(19) United States
(12) Patent Application Publication
(10) Pub. No.: US 2026/0369988 A1
(43) Pub. Date: Nov. 19, 2026

(54) HIGH FREQUENCY FAULT DETECTION FOR FMPS

(71) Applicant: Schneider Electric USA, Inc., Andover, MA (US)

(72) Inventor: John J. SHEA, Wake Forest, NC (US)

(73) Assignee: Schneider Electric USA, Inc., Boston, MA (US)

(21) Appl. No.: 19/208,841

(22) Filed: May 15, 2025

(51) Int. Cl. H02H 7/22; H01B 9/02; H02H 1/00

(52) U.S. Cl. CPC H02H 7/226; H01B 9/02; H02H 1/0007

(57) ABSTRACT

Embodiments herein describe techniques that can be used to detect faults in a cable (e.g., a cable containing a twisted pair of conductors, or an optical fiber cable with embedded conductors) by injecting a fault detection signal onto the cable. In one embodiment, the fault detection signal is isolated on the cable by two electrical filters that have high impedance at the frequency of the detection signal but low impedance at the frequency of a power transmission signal. The system measures an electrical parameter associated with the fault detection signal to identify when there is a fault and disconnect the cable from a power source.

### BACKGROUND

A fault-managed power system (FMPS), also known as Class 4 power, is a type of power distribution system designed to safely deliver high power levels over long distances while minimizing the risk of fire and shock by limiting energy transferred during fault conditions. Despite having potentially hazardous voltages (e.g., 50-450 volts (V)), FMPS aims to minimize the effects of electrical shock during line-to-ground faults, line-to-line faults, and cross-line faults. The reaction time of the FMPS allows the ability to detect a fault and disconnect the cable from a power source.

### SUMMARY

One embodiment described herein is a system that includes a first electrical filter configured to couple to a first end of a power cable, a second electrical filter configured to couple to a second end of the power cable, a source configured to transmit a fault detection signal onto the power cable where the first and second electrical filters are configured to isolate the fault detection signal on the power cable, a sensor configured to measure an electrical parameter associated with the fault detection signal, and a controller configured to open a switch to disconnect the power cable from a power source when the electrical parameter meets or exceeds a threshold.

One embodiment described herein is a method that includes inserting a fault detection signal onto a power cable, wherein the fault detection signal is isolated on the power cable using respective electrical filters on respective ends of the power cable, measuring an electrical parameter generated by the fault detection signal, and, upon determining the electrical parameter meets or exceeds a threshold, disconnecting the power cable from a power source.

One embodiment described herein is a system that includes a first electrical filter configured to couple to a first end of two conductors of a cable, a second electrical filter configured to couple to a second end of the two conductors of the cable, a source configured to transmit a fault detection signal onto the two conductors, wherein the first and second electrical filters are configured to isolate the fault detection signal on the two conductors, a sensor configured to measure an electrical parameter associated with the fault detection signal, and a controller configured to open a switch to disconnect the cable from a power source when the electrical parameter satisfies a threshold.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only example embodiments and are therefore not to be considered limiting of its scope, may admit to other equally effective embodiments.

FIG. 1 illustrates a FMPS that uses a high-frequency source to detect faults, according to one embodiment.

FIG. 2 illustrates a FMPS that uses a high-frequency source to detect faults, according to one embodiment.

FIG. 3 is a flowchart for detecting faults using a high-frequency source, according to one embodiment.

FIG. 4 illustrates a FMPS that uses a high-frequency source to detect faults, according to one embodiment.

FIG. 5 illustrates a FMPS that detects faults using a shielded cable, according to one embodiment.

FIG. 6 illustrates different power transmission waveforms, according to several embodiments.

### DETAILED DESCRIPTION

Embodiments herein describe techniques that can be used to detect faults in a power cable (e.g., a cable containing a twisted pair of conductors, an optical fiber cable with embedded conductors, and the like) by injecting a high-frequency (HF) low voltage fault detection signal onto the cable. In this context, “high-frequency” means the frequency of the fault detection signal is greater than the frequency of the power signal (which is a direct current (DC) or alternating current (AC) of, e.g., 60-100 hertz (Hz)). For example, the HF signal may have a frequency of at least 1 kilohertz (kHz), and may range from 1 kHz to 5 MHz.

In one embodiment, the HF fault detection signal is isolated on the cable by two electrical filters that have high impedance at the frequency of the detection signal but low impedance at the frequency of the power signal. For example, the electrical filters may be wave traps formed using tank circuits with a resonant frequency at the frequency of the HF detection signal (e.g., 1 kHz-10 MHz) so to provide a high impedance to block the detection signal while simultaneously permitting the lower frequency power signal to pass through. Or, in another embodiment, the electrical filters may be inductors or low-pass filters that allow the low-frequency power signal to propagate between a power source and a load but block the HF fault detection signal. The low-pass filter can have a cutoff frequency below the HF detection signal.

The FMPS can measure the current created by the HF fault detection signal. Because the HF detection signal is isolated onto the cable by the electrical filters, when there is no fault, there is no current associated with the HF detection signal. However, if the FMPS measures a current caused by the HF fault detection signal, this is an indication of a possible fault (e.g., a line-to-ground fault, line-to-line fault, or cross-line fault). In response, the FMPS can quickly (e.g., within a few milliseconds or within microseconds) disconnect the power source from the cable, thereby preventing a human touching the conductors in the cable from being electrocuted.

However, as cables increase in length, so does the capacitance between the cables which can result in current being measured at the same frequency of the HF detection signal. This current could be caused by a fault, or by the internal cable capacitance. As such, in one embodiment the cable may be shielded where the shielding is connected to one of the conductors in the cable. This eliminates stray cable capacitance effects so the current sensor measures only the current caused by HF fault detection signal.

Advantageously, the embodiments herein are independent of power transmission unlike other fault detection systems which may, for example, include sensing cycles that are used to detect faults and are synchronized with cycles used to transmit power. Thus, the HF source can detect faults regardless of the technique used to transmit power on the cable (e.g., DC, pulsed DC, or AC). Moreover, while discussed in the context of FMPS, the embodiments herein are not limited to such and can be used in any power transmission technique (e.g., power over Ethernet (PoE), electrical distribution within a home or business, etc.).

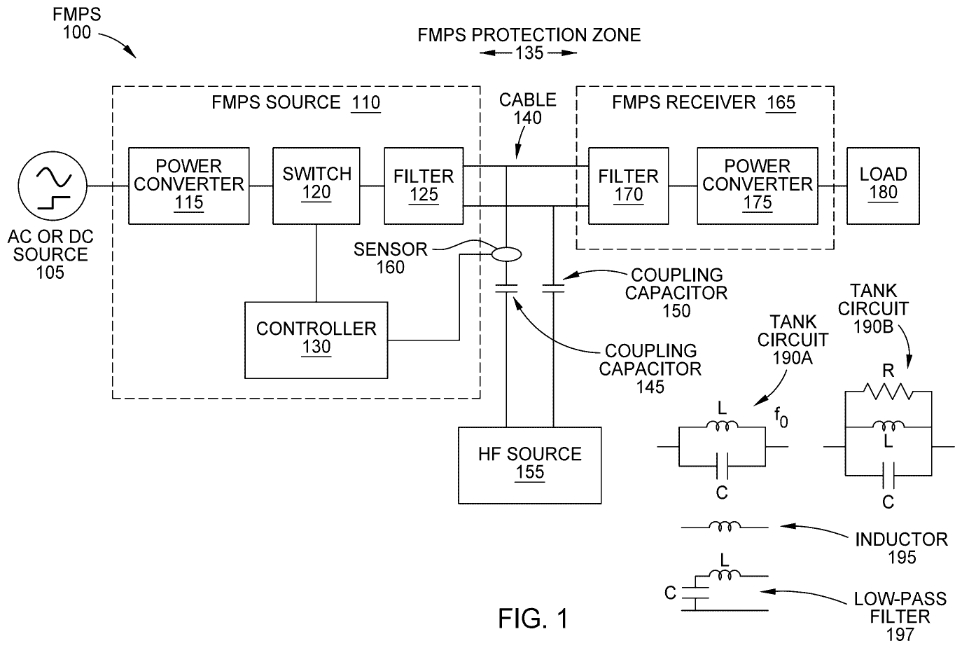

FIG. 1 illustrates a FMPS 100 that uses a HF source 155 to detect faults, according to one embodiment. The FMPS 100 includes an AC or DC power source 105 that generates AC or DC power that is provided to a FMPS source 110. The source 110 can be a single component (or unit), or can include a combination of separate components that are interconnected.

The FMPS source 110 includes a power converter 115, switch 120, electrical filter 125, and controller 130. The power converter 115 can convert the AC or DC power received from the AC or DC power source 105 into a power signal that is transmitted along a cable 140 (e.g., a power cable). For example, the power converter 115 may convert an AC power signal into a DC power signal, or vice versa. In other embodiments, the power converter 115 may not change the type of the power signal (e.g., keep the power signal a DC power signal) but step up or step down the voltage. However, in other embodiments, the AC or DC power source 105 may generate a power signal with the desired type and voltage as the power transmitted on the cable 140, in which case the power converter 115 can be omitted.

In one embodiment, the switch 120 is a solid-state switch (e.g., a semiconductor switch) which can be switched open and closed much faster than electromechanical switches. As discussed below, the switch 120 can be opened when a fault is detected, which quickly disconnects (e.g., within a microseconds) the cable 140 from the power source 105, thereby mitigating the chance that a person is harmed by an electrical shock.

The electrical filter 125 is a circuit element that isolates a HF fault detection signal on the cable 140. That is, the FMPS 100 includes the electrical filter 125 disposed on one end of the cable 140 and an electrical filter 170 disposed on the other end of the cable 140. The electrical filters 125, 170 are designed to have a high impedance at the frequency of the HF fault detection signal generated by the HF source 155 but a lower impedance at the frequency of the power signal being transmitted on the cable 140. As such, the electrical filters 125, 170 isolate the HF fault detection signal on the cable 140 so that it does not leak out into the FMPS source 110 or a FMPS receiver 165. This will be discussed in more detail below. At the same time, a power signal can be transmitted from the power source 105 to the load 180 via the electrical filters 125, 170 and the cable 140.

The controller 130 can be a hardware controller (e.g., a processor or micro controller), firmware, software, or a combination thereof. The controller 130 receives an electrical parameter measurement from the sensor 160 indicating whether there is a fault in the cable 140. In one embodiment, the electrical parameter measurement is a current measurement captured by the sensor 160 (e.g., a current transformer (CT), resistive shunt, fluxgate, hall effect sensor, or Rogowski coil), but is not limited to such. For example, the sensor 160 may detect voltage changes or capacitance changes to detect a fault in the FMPS 100. Further, in one embodiment, the sensor 160 provides an analog measurement of the electrical parameter to the controller 130, but in other embodiments the sensor 160 may provide a digital signal to the controller 130.

In one embodiment, the controller 130 compares the electrical parameter measurement received from the sensor 160 with one or more thresholds to determine a fault in the FMPS 100. For example, if the current measured by the sensor meets or exceeds a threshold (or more generally, satisfies a threshold), the controller 130 opens the switch 120 which disconnects the power source 105 from the cable 140. As such, the FMPS 100 establishes a FMPS protection zone 135 that extends between the electrical filters 125 and 170. In protection zone 135, the controller 130 can use the HF fault detection signal generated by the HF source 155 to detect a fault and disconnect the cable 140. In this manner, the FMPS protection zone 135 provides shock protection for any faults between the FMPS source 110 and FMPS receiver 165. The FMPS protection zone 135 can also prevent fires from overload series arcing and parallel arcing.

The cable 140 can be any suitable electrical cable or an optic cable that includes conductors for forming a current path between the AC or DC power source 105 and a load 180. For example, in one embodiment the cable 140 includes one or more twisted pairs to form the conductors in the cable 140. However, in another example the power and modulated data may be transmitted on the same pair of conductors of the cable 140. The electrical filters 125 and 170 may be coupled to opposite first and second ends of the conductors (e.g., two conductors) of the cable 140.

In another example, the cable 140 is a fiber optic cable where modulated data is transmitted optically in a core of the cable while power is transmitted using conductors embedded in the same cable.

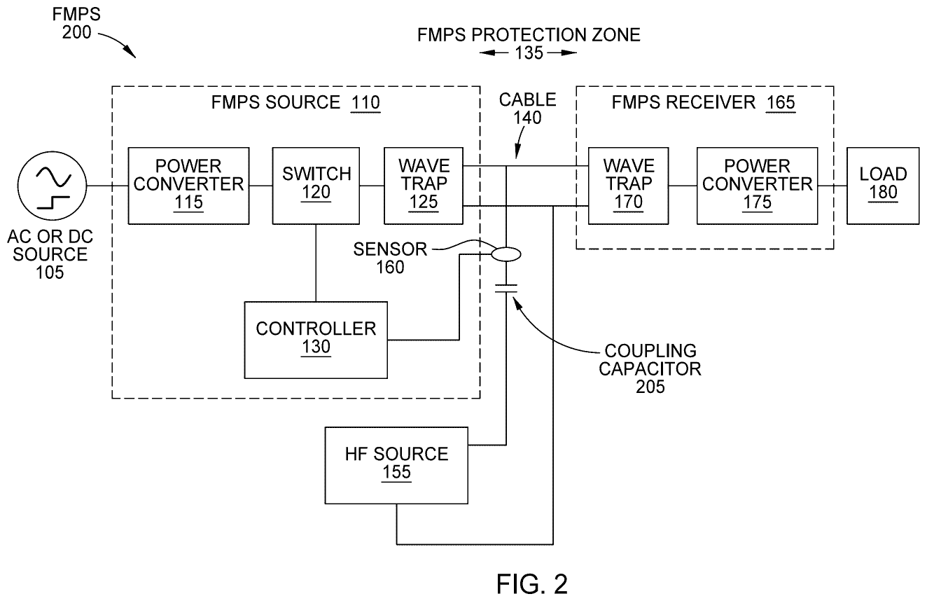

The HF source 155 can be any suitable HF signal generator. The HF fault detection signal generated by the HF source 155 is coupled to the conductors of the cable 140 using coupling capacitors 145 and 150. These capacitors 145 and 150 have high impedance for DC signals and low frequency AC signals (e.g., 60 or 100 Hz) typically used to transmit power. As such, the capacitors 145 and 150 can serve as DC blocking capacitors to prevent the power signal transmitted on the cable 140 from reaching (and potentially damaging) the HF source 155. Optionally, only one capacitor (e.g., capacitor 145) can be used if the HF source 155 is isolated from the power source 105 as shown in FIG. 2.

The fault detection signal may have a frequency of at least 1 kHz, and may range from 1 kHz to 5 MHz. The capacitors 145 and 150 can have capacitance values to have low impedance at the frequency of the HF detection signal. That way, the capacitors 145 and 150 enable the HF detection signal to be transmitted (or inserted) onto the cable 140 but block the power signal from reaching the HF source 155. That is, the capacitors 145 and 150 can serve as DC-blocking capacitors. In addition, the HF fault detection signal can be a low voltage signal (e.g., have a voltage much smaller than the voltage of the power signal).

When there is no fault (e.g., a line-to-ground fault, line-to-line fault, or cross-line fault), then very little or no current is sensed by the sensor 160. This is because the electrical filters 125 and 170 prevent the HF fault detection signal from generating a current. However, when there is a fault, the current begins to flow through the sensor 160. If the current exceeds a threshold, the controller 130 opens the switch 120 to disconnect the power source 105 from the cable 140.

In one embodiment, the HF source 155 remains connected to the cable 140 during a fault. Because the HF detection signal is a low voltage signal, it cannot harm a person who may be touching the conductors of the cable 140. Moreover, because the HF source 155 can remain connected to the cable 140, if the fault condition stops (e.g., the person no longer touches a conductor in the cable), the current caused by the HF detection signal will cease and the controller 130 can reconnect the power source 105 to the cable 140, which is referred to herein as an auto-restart. This may be preferred in some implementations such as information technology (IT) (e.g., data centers) where down time can cause major disruptions. However, in other embodiments, the controller 130 may keep the switch 120 disconnected until a manual reset is performed, which may require human intervention.

As shown, the cable 140 terminates at the FMPS receiver 165, which includes the electrical filter 170 and a power converter 175. The electrical filters 170 may be the same circuit as the electrical filter 125, but that is not a requirement. The electrical filters 125 and 170 can be any circuit that provides high impedance at the frequency of the HF detection signal but low impedance at the frequency of the power signal in order to enable efficient power transmission.

The power converter 175 converts the power signal to the desired power signal for the load 180. For example, the cable 140 may transmit a DC signal but the load 180 uses an AC signal, or the cable 140 may transmit a higher DC voltage than desired by the load 180. For example, it is often more efficient to transmit power long distances (e.g., half a kilometer or more) using a higher voltage. In those cases, the power converter 175 can convert the power signal transmitted by the cable 140 to the power signal used by the load 180. However, if the FMPS 100 transmits the same power type on the cable 140 that is used by the load 180 then the power converter 175 can be omitted.

FIG. 1 also illustrates different implementations of the electrical filters 125, 170. In one embodiment, the electrical filters 125, 170 can be implemented using a wave trap 190A or 190B, which includes respective tanks circuits formed from an inductor and a capacitor connected in parallel. Each tank circuit can thus be a parallel resonant tank circuit. The wave trap 190B includes a resistor in parallel with the capacitor and the inductor. The resistor (R) can be used to inverse the bandwidth of the wave trap 190B to allow for component tolerance variation, although this is a tradeoff that may result in reduced peak impedance at resonance. The wave trap 190A or 190B helps to block radio frequency (RF) current from going toward a source or a load at a center frequency, as the wave trap 190A or 190B can provide a higher impedance than alternatives such as a low-pass filter or a standalone inductor.

The inductance L and capacitance C values of the inductor and capacitor can be selected so that their resonant frequency fₒ is at the frequency of the HF detection signal emitted by the HF source 155. The resonant frequency fₒ for the wave trap 190A is defined in the following equation:

$${f}_{o} = \frac{1}{2 π \sqrt{LC}}$$

For example, the HF source 155 can be a sinewave generator that produces a HF fault detection signal at the resonant frequency fₒ of the electrical filters 125, 170. Doing so creates a high impedance seen by the HF detection signal, effectively isolating the cable 140 from the source 105 and load 180. However, for signals that are not at resonance (e.g., the power signal), the wave traps 190A and 190B has low impedance so these signals can be transmitted through the cable 140. Parallel resonant tank circuits providing the wave traps 190A, 190B may have the same resonant frequency fₒ at a frequency of the HF fault detection signal, because these tank circuits may have the same center frequency. It may be beneficial to electrically isolate (e.g., using the tank circuits) the FMPS source 110 and the load 180 from the cable 140 at the frequency of the HF source 155.

An inductor 195 connected in series with the cable 140 is another implementation of the electrical filters 125 and 170. The inductor 195 can have a value that functions as an AC block at the frequency of the detection signal, but have low impedance at the frequency of the power signal.

A low-pass filter 197 is another implementation of the electrical filters 125 and 170. The low-pass filter 197 includes a capacitor (C) connected to an inductor (L), but this is just one example of a suitable low-pass filter design. The values of the capacitor and inductor can have values that attenuates the frequency of the detection signal but has low impedance at the frequency of the power signal. For example, the cut-off frequency of the low-pass filter can be below the frequency of the HF detection signal.

While FIG. 1 illustrates three different implementations of electrical filters for blocking the HF detection signal, the embodiments herein are not limited to such. Any circuit that selectively blocks or isolates the HF frequency detection signal while permitting the power signal to propagate through the cable 140 can be used.

Advantageously, the electrical filters 125 and 170 shown in FIG. 1 can include passive circuit components (in contrast to active circuits that are powered). Passive circuit components can be easier to package since they can be placed in areas that do not receive power. Moreover, passive circuits can be smaller than functionally equivalent active circuits. Thus, instead of having a separate FMPS receiver 165 (e.g., a box or container), the electrical filters 125 and 170 (and the power converter 175) could be included in the load 180. This can reduce the number of separate or individual components used to install the FMPS 100.

FIG. 2 illustrates a FMPS 200 that uses the HF source 155 to detect faults, according to one embodiment. The FMPS 200 includes many of the same components as FMPS 100 in FIG. 1, as indicated by using the same reference numbers. As such, these components are not discussed in detail here. However, FIG. 2 differs from FIG. 1 by illustrating a different technique for connecting the HF source 155 to the cable 140. In this example, one port of the HF source 155 is connected to the coupling capacitor 205, while the other port of the HF source 155 is coupled to directly to the cable 140.

Like the coupling capacitors in FIG. 1, the coupling capacitor 205 is coupled to one conductor in the cable 140 while the return path is connected to the other conductor of the cable 140.

In any case, the HF source 155 functions similar to FIG. 1 where the HF source 155 generates a HF detection signal that is transmitted onto the cable 140 via the coupling capacitor 205 except that the HF source 155 is isolated from the power source 105. When there is a fault, a change in an electrical parameter can be detected by the sensor 160 which is then used to open the switch 120, as discussed above. Further, the coupling capacitor 205 can serve as DC-blocking capacitor, preventing any unwanted DC voltages (or low-frequency AC power signals) from affecting the HF source 155.

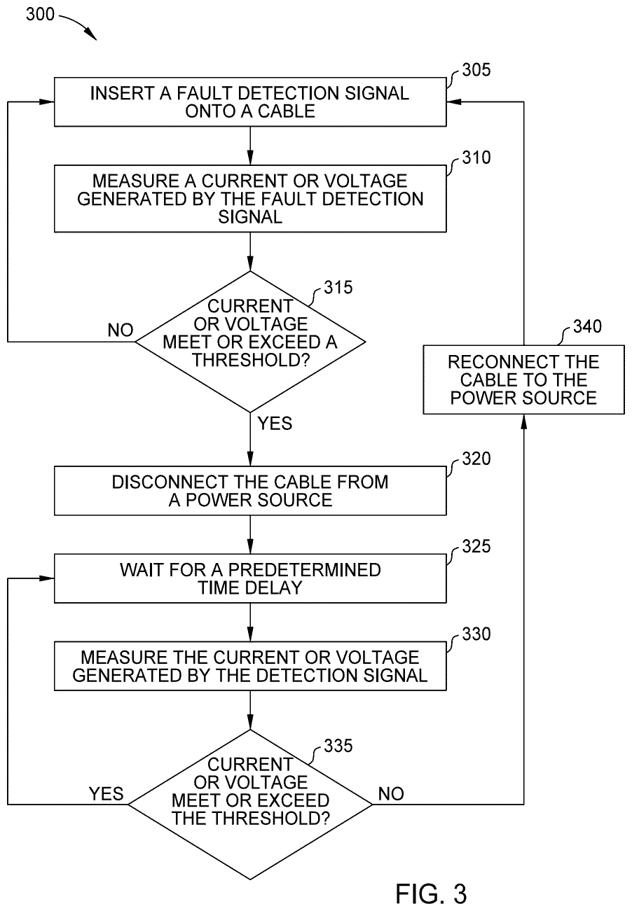

FIG. 3 is a flowchart of a method 300 for detecting faults using a HF source, according to one embodiment. At block 305, a HF source (e.g., the HF source 155 in FIG. 1 or 2) inserts a HF fault detection signal onto a cable (e.g., a power cable). The cable can include at least two conductors which can be, for example, a twisted pair, or conductors integrated into an optical fiber. In one embodiment, the cable is a Class 4 cable as defined by the National Electrical Code (NEC), which are also referred to as FMPS cables. However, the embodiments herein are not limited to FMPS and may be used in other power transmission techniques in order to detect and respond to faults.

At block 310, a sensor (e.g., the sensor 160 in FIG. 1) measures a current or voltage generated by the HF fault detection signal. For example, due to electrical filters which isolate the HF fault detection signal on the cable, when there is no fault present in the system, little to no current flows through the sensor. However, when there is a fault which connects the cable to ground (e.g., a line-to-ground fault) or connects the conductors in the cable to each other (e.g., a line-to-line fault) or connects the cable to another cable for a different FMPS (e.g., cross-line fault), current begins to flow which is detected by the sensor. While the fault can be a galvanic connection (i.e., a short), the fault can be caused by a human touching a conductor in the cable. There, the fault is the current flowing through the human body. For example, line-to-line could be from hand-to-hand and line-to-ground could be from hand-to-ground. Another example of a fault is an unintended series arc. While current is specifically described, voltage, capacitance, or other suitable electrical parameter can be measured in order to detect a fault.

At block 315, a controller (e.g., the controller 130 in FIG. 1) determines whether the measured current or voltage meets or exceeds a threshold. If not, this means there is no fault in the system and the method 300 returns to block 305 where the HF source continues to insert the HF detection signal onto the cable. The blocks 305-315 can repeat.

However, if the measured electrical parameter does meet or exceed the threshold, the method 300 instead proceeds to block 320 where the controller disconnects the cable from the power source. Using FIG. 1 as an example, the controller 130 can open the switch 120 to disconnect the cable 140 from the power source 105.

If the switch 120 is a solid-state switch, disconnecting the cable 140 can occur much quicker than using an electromechanical switch. As such, this can reduce the chances that a person is shocked by the fault.

Further, in one embodiment, the HF fault detection signal is transmitted at the same time a power signal is transmitted on the cable. Thus, unlike other shock detection methods where fault detection is performed separate from power transmission (e.g., in one cycle performing fault detection, and another cycle performing power transmission), method 300 can perform fault detection in parallel with, or independently from, power transmission. That is, the method 300 can detect a fault when no power is being transmitted on the cable, or when power is being transmitted on the cable. For example, the system may perform blocks 305-315 before transmitting power on the cable as part of an initialization or installation of the system. If a fault is detected, the system may never transmit power on the cable. However, if no fault is detected, the system can begin to transmit power on the cable while also continuing to insert the HF detection signal onto the cable. If a fault is later detected, the method 300 can quickly disconnect the power source as discussed above.

After disconnecting the cable at block 320, at block 325 the controller waits for a predetermined time delay as part of an auto-restart feature. For example, this time delay may be approximately 1 millisecond to three seconds.

At block 330, the sensor measures the current or voltage generated by the HF detection signal, which can be performed in the same manner as described at block 310. That is, block 330 assumes that the HF source continues to insert or drive the HF detection signal onto the cable.

At block 335, the controller determines whether the measured current or voltage meets or exceeds a threshold. If the measured current or voltage meets or exceeds the threshold, this means the fault is still present and as such, the switch keeps the power source disconnected from the cable. Blocks 325-335 can then repeat to determine when the conditions causing the fault have stopped.

However, if the measured current or voltage is below the threshold, this means the fault has stopped. In that case, the method 300 proceeds to block 340 where the controller reconnects the cable to the power source (e.g., the power source 105). In other words, the method 300 auto-restarts the FMPS by reconnecting the cable to the power source without human intervention.

While some implementations of FMPS may prefer auto-restart, others may not. For example, for IT loads, auto-restart may be preferred in order to minimize down time. However, for manufacturing systems, it may be preferred to not auto-restart since switching off and on the load to the power source may damage the load. In those cases, after disconnecting the cable from the power source, a human may have to intervene to reconnect the cable to the power source (e.g., a manual reset).

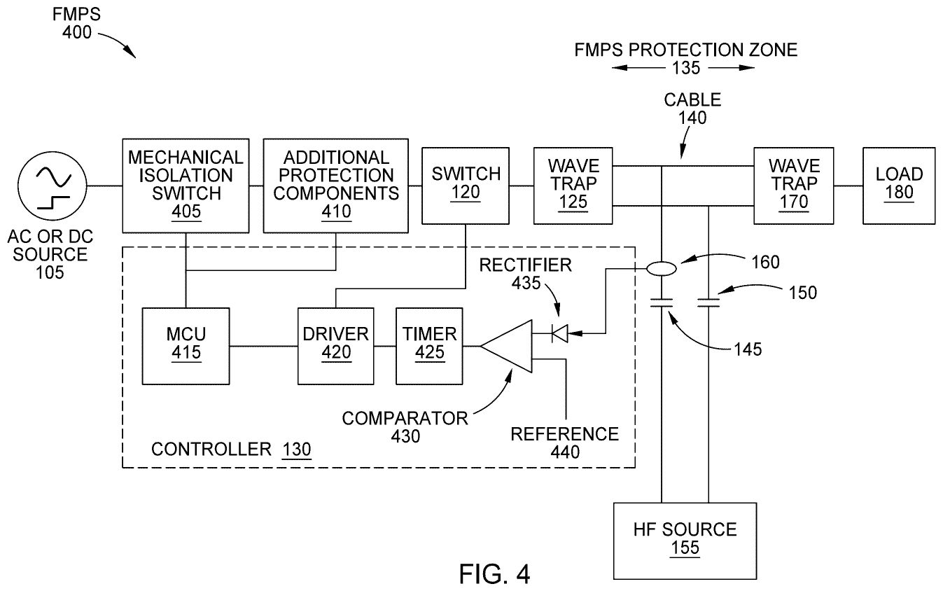

FIG. 4 illustrates a FMPS 400 that uses the HF source 155 to detect faults, according to one embodiment. FMPS 400 includes many of the same components as FMPS 100 in FIG. 1, as indicated by using the same reference numbers. As such, these components are not discussed in detail here. However, FIG. 4 also includes a mechanical isolation switch 405, additional protection components 410, as well as illustrating example components within the controller 130.

The mechanical isolation switch 405 can also be triggered when the controller 130 determines a fault as discussed above, or could be operated by a human. The mechanical isolation switch 405 can provide additional protection between the cable 140 and the AC or DC power source 105 (instead of relying solely on the switch 120). However, the mechanical isolation switch 405 may take more time to open/close than the switch 120. Thus, the switch 120 can provide quick disconnection between the AC or DC source 105 while the mechanical isolation switch 405 provides extra assurance that the cable 140 has been electrically isolated from the AC or DC source 105.

The additional protection components 410 can include an Arc Fault Circuit Interrupter (AFCI), a ground fault circuit interrupter (GFCI), overload detection circuits, short circuit detection circuits, and the like. These protection components 410 can work independently of, or with, the sensor 160 and the controller 130 to identify safety hazards associated with the FMPS 400.

In this example, the controller 130 includes a micro-controller unit (MCU) 415, a driver 420, a timer 425, a comparator 430, a rectifier 435, and a reference 440. The MCU 415 can control the additional protection components 410 using any number of sensors (which can include the sensor 160) in the FMPS 400. Thus, the FMPS 400 can include additional electrical protection beyond just the switch 120.

The electrical parameter measured by the sensor 160 (e.g., HF current in this example) is received at the rectifier 435 which is in turn coupled to one input of the comparator 430. The comparator 430 compares the rectified signal provided by the rectifier 435 to the reference 440. In this example, the reference 440 is a threshold (e.g., the threshold discussed in blocks 315 and 335 of method 300) that is compared to the measurement provided by the sensor 160. For example, when the output of the rectifier 435 exceeds the reference 440, the output of the comparator 430 is a first value (e.g., a low voltage) but when the output of the rectifier 435 is below the reference 440, the output of the comparator is a second value (e.g., a high voltage).

The output of the comparator 430 is provided to the timer 425 which determines the time delay to auto-restart the system. When the comparator voltage threshold is exceeded, the comparator 430 triggers the timer 425 and also triggers the driver 420 to turn off the switch.

The output of the timer 425 controls the driver 420 which in turn controls the switch 120 as discussed in FIG. 3. For example, when current measured by the sensor 160 meets or exceeds the reference 440 (e.g., the threshold), the driver 420 opens the switch 120. Moreover, when the current measured by the sensor 160 falls below the reference 440, the output of the comparator 430 flips after the timer 425 times out so that the driver 420 closes the switch 120, thereby enabling an auto-restart feature. However, as discussed above, this auto-restart feature is optional. In another embodiment, the MCU 415 may not permit the driver 420 to close the switch 120 once it has been opened without human intervention.

In another embodiment, an amplifier can measure the magnitude of the current measured by the sensor 160 and trigger the comparator 430 if the current detection signal exceeds a certain duration (i.e., time current curve)

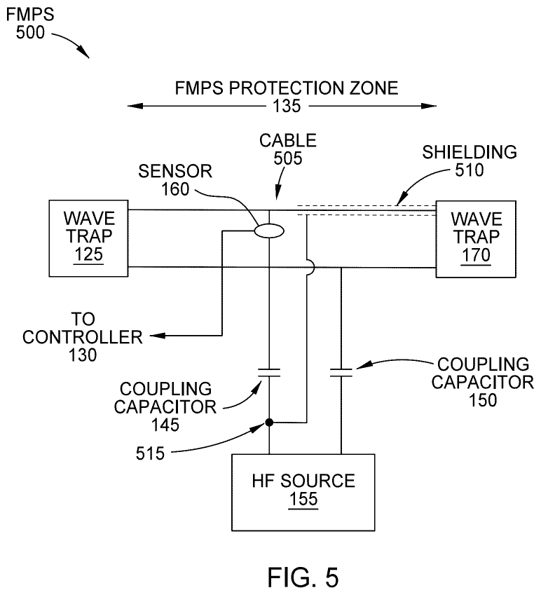

FIG. 5 illustrates a FMPS 500 that detects faults using a shielded cable, according to one embodiment. As mentioned above when discussing FIG. 1, the electrical filters 125 and 170 can be implemented using wave traps, inductors, or low pass filters to isolate the HF fault detection signal in the cable. Lower frequency fault detections signals (e.g., 1-100 kHz) require larger inductors than higher frequency fault detection signals (e.g., 1-5 MHz). As such, it may be desirable to use a higher frequency fault detection signal since this means smaller inductors can be used, which can reduce the cost and size of the FMPS source and receiver that contain the electrical filters 125 and 170. A magnetic core could also be used in the inductor, rather than an air core, which means the inductor can be smaller, but this causes the quality factor (Q) of the inductor to decrease, thus reducing the impedance at the resonant frequency of the tank circuit.

However, when using a higher frequency fault detection signal, the sensor 160 can begin to measure a current caused by a capacitive coupling between the conductors of the cable 505. This capacitance induced current can be mistaken as a fault current which causes the controller 130 to open the switch as discussed above. This capacitance induced current is also increased as the length of the cable 505 increases. This means that for longer cables, lower frequency detection signals may be used to avoid measuring the capacitance induced current, which in turn means larger inductors have to be used, thereby driving up cost and packaging sizes.

To avoid measuring the capacitance induced current from the capacitive coupling between the conductors in the cable, a shielded cable 505 is used which includes a shielding 510 around one of the conductors which includes the current sensor. As shown, the shielding 510 (e.g., a conductive mesh) is electrically connected to a node 515 between the coupling capacitor 145 and the HF source 155. As a result, the capacitance induced current now occurs between the shielding 510 and the return conductor which is not seen by the sensor 160 (e.g., an alternating current sensor). Put differently, the sensor 160 does not measure any current caused by the coupling capacitance between the two conductors in the cable 505. As a result, longer cables 505 can be used (e.g., 2 kilometers (km) or longer), along with higher frequency detection signals (thereby permitting smaller inductors) without inadvertently opening the switch because of the capacitance induced current.

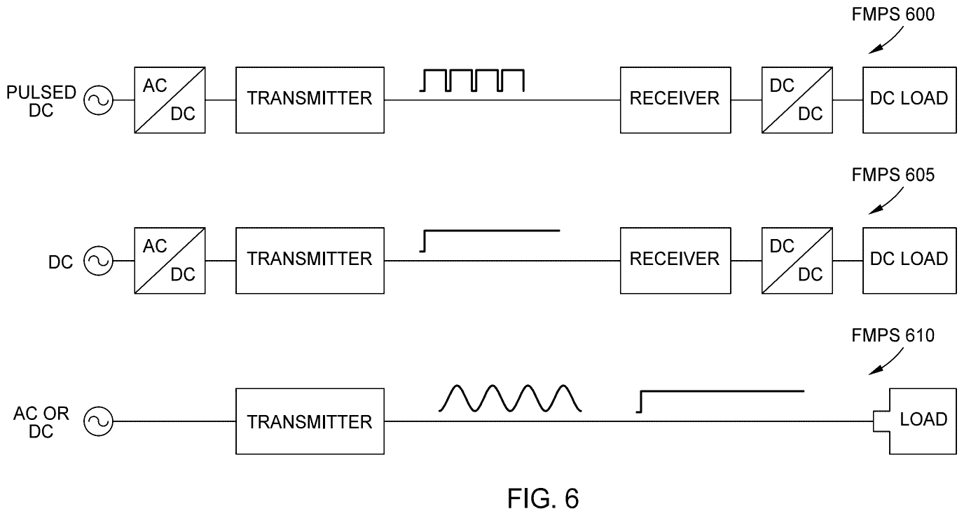

FIG. 6 illustrates different power transmission waveforms that are suitable for FMPS, according to several embodiments. In FMPS 600, a pulsed DC signal is used to transmit power to the load. In FMPS 605, a DC signal is used to transmit power to a load. In FMPS 610, an AC or DC signal is used to transmit power to a load.

The fault detection signal discussed above can be used to detect a fault in any of the FMPS arrangements illustrated in FIG. 6. In other words, isolating a HF fault detection signal onto the cables and then measuring a current to detect a fault can be performed regardless of the type of power signal being used in the FMPS. As such, FIG. 6 illustrates that techniques described herein can apply to many different types of FMPS arrangements and techniques. Further, the embodiments herein could also be used in a three-phase AC system (e.g., Y and delta configurations).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

What is claimed is:

1. A system, comprising:
a first electrical filter configured to couple to a first end of a power cable;
a second electrical filter configured to couple to a second end of the power cable;
a source configured to transmit a fault detection signal onto the power cable, wherein the first and second electrical filters are configured to isolate the fault detection signal on the power cable;
a sensor configured to measure an electrical parameter associated with the fault detection signal; and
a controller configured to open a switch to disconnect the power cable from a power source when the electrical parameter meets or exceeds a threshold.

2. The system of claim 1, wherein the first and second electrical filters comprise respective inductors.

3. The system of claim 2, wherein the first and second electrical filters comprise respective tank circuits that provide wave traps, the respective tank circuits comprising the respective inductors in parallel with respective capacitors.

4. The system of claim 3, wherein the respective tank circuits comprise respective resistors in parallel with the respective inductors and capacitors.

5. The system of claim 3, wherein the respective tank circuits have a same resonant frequency at a frequency of the fault detection signal.

6. The system of claim 1, wherein the system is a fault-managed power system (FMPS).

7. The system of claim 6, wherein the power cable is a Class 4 cable as defined by National Electrical Code (NEC).

8. The system of claim 1, wherein the fault detection signal has a frequency greater than 1 kilohertz (kHz).

9. The system of claim 1, wherein at least one conductor in the power cable includes shielding, and wherein the shielding is coupled to a node between the sensor and the source.

10. The system of claim 9, wherein the shielding prevents the sensor from measuring a current caused by capacitive coupling between two conductors in the power cable, wherein the two conductors includes the at least one conductor.

11. The system of claim 1, wherein the sensor is a configured to measure current only when a line-to-ground fault, a line-to-line fault, or cross-line fault occurs.

12. The system of claim 1, wherein the switch is a solid-state switch.

13. The system of claim 1, wherein the controller is configured to reconnect, without human intervention, the power source to the power cable when the electrical parameter associated with the fault detection signal falls below the threshold.

14. The system of claim 13, wherein the controller is configured to wait a predetermined time delay after disconnecting the power cable from the power source before determining whether the electrical parameter associated with the fault detection signal has fallen below the threshold, wherein the threshold is predetermined.

15. A method comprising:
inserting a fault detection signal onto a power cable, wherein the fault detection signal is isolated on the power cable using respective electrical filters on respective ends of the power cable;
measuring an electrical parameter generated by the fault detection signal; and
upon determining the electrical parameter meets or exceeds a threshold, disconnecting the power cable from a power source.

16. A system, comprising:
a first electrical filter configured to couple to a first end of two conductors of a cable;
a second electrical filter configured to couple to a second end of the two conductors of the cable;
a source configured to transmit a fault detection signal onto the two conductors, wherein the first and second electrical filters are configured to isolate the fault detection signal on the two conductors;
a sensor configured to measure an electrical parameter associated with the fault detection signal; and
a controller configured to open a switch to disconnect the cable from a power source when the electrical parameter satisfies a threshold.

17. The system of claim 16, wherein the first and second electrical filters comprise respective inductors.

18. The system of claim 17, wherein the first and second electrical filters comprise respective tank circuits that provide wave traps, the respective tank circuits comprising the respective inductors in parallel with respective capacitors and respective resistors.

19. The system of claim 18, wherein the respective tank circuits have a same resonant frequency at a frequency of the fault detection signal.

20. The system of claim 16, wherein the first and second electrical filters have a high impedance at a frequency of the fault detection signal but a low impedance at a frequency of a power signal transmitted on the cable by the power source.
